(19) United States
(12) Patent Application Publication
(10) Pub. No.: US 2025/0114795 A1
(43) Pub. Date: Apr. 10, 2025

(54) Linear Pulverizer

(71) Applicant: Rotochopper, Inc., St. Martin, MN (US)

(72) Inventors: Jamey Brick, Paynesville, MN (US); Nick D. Lieser, Paynesville, MN (US); Todd J. Marquardsen, Swanville, MN (US)

(21) Appl. No.: 18/907,675

(22) Filed: Oct. 7, 2024

Related U.S. Application Data
(60) Provisional application No. 63/542,660, filed on Oct. 5, 2023.

(51) Int. Cl. B02C 1/00; B02C 23/16

(52) U.S. Cl. CPC B02C 1/005; B02C 23/16; B02C 2023/165

(57) ABSTRACT

A pulverizer apparatus includes a first rail assembly and a second rail assembly. The first rail assembly includes a first plurality of rails. Each of the first plurality of rails are separated from each other by first gaps. The second rail assembly includes a second plurality of rails separated from each other by second gaps. A first linear actuator is secured to the first rail assembly. The first rail assembly is movable along a first linear path via actuation of the first linear actuator. The first plurality of rails is receivable in the second gaps of the second rail assembly.

### BACKGROUND

The present disclosure relates generally to devices, systems, and methods for a linear pulverizer. In general, pulverizers, grinders, and/or shredders may be used to process solid waste materials. Waste materials from construction sites or manufacturing facilities may include, for example, wood pallets, wood trimmings, siding, drywall, roofing materials, packaging, sheet metal, PVC pipes, etc. Waste materials may occupy a large volume on the site and during transportation to a waste management facility. Pulverizers, grinders, and/or shredders may be used to process (or break down) the waste material to a smaller volume to reduce storage and transportation costs. Various systems are known for processing solid waste material. In general, these systems include a rotational component configured to pulverize, grind, and/or shred the solid waste material into a processed waste material.

### OVERVIEW

According to some embodiments, a pulverizer apparatus includes a first rail assembly and a second rail assembly. The first rail assembly includes a first plurality of rails. Each of the first plurality of rails are separated from each other by first gaps. The second rail assembly includes a second plurality of rails separated from each other by second gaps. A first linear actuator is secured to the first rail assembly. The first rail assembly is movable along a first linear path via actuation of the first linear actuator. The first plurality of rails is receivable in the second gaps of the second rail assembly.

According to some embodiments, a pulverizer system includes a first rail assembly and a second rail assembly. The first rail assembly includes a first plurality of rails extending along a first plane. Each of the first plurality of rails are separated from each other by first gaps. The plurality of first rails includes at least one rail tooth. The second rail assembly includes a second plurality of rails extending along a second plane. Each of the second plurality of rails separated from each other by second gaps. The first plurality of rails is receivable in the second gaps and the second plurality of rails is receivable in the first gaps. A first linear actuator is secured to the first rail assembly. The first linear actuator is actuatable along a first linear path to urge the first rail assembly at least partially through the second gaps of the second rail assembly. A second linear actuator is secured to the second rail assembly. The second linear actuator is actuatable along a second linear path to urge the second rail assembly at least partially through the first gaps of the first rail assembly. The pulverizer system includes a prime mover. The prime mover provides power to one or more of the first linear actuator and the second linear actuator.

According to some embodiments, a method of pulverizing waste material includes providing a pulverizer apparatus. The pulverizer apparatus includes a first rail assembly having a first plurality of rails separated from each other by first gaps. The pulverizer apparatus includes a second rail assembly having a second plurality of rails separated from each other by second gaps. A first linear actuator secured to the first rail assembly is actuated. The first rail assembly is movable along a first linear path via actuation of the first linear actuator. A second linear actuator secured to the second rail assembly is actuated. The second rail assembly is movable along a second linear path via actuation of the second linear actuator. Solid waste material is inserted between the first rail assembly and the second rail assembly. The first linear path intersects the second linear path.

These and other examples and features of the present devices, systems, and methods will be set forth, at least in part, in the following Detailed Description. This Overview is intended to provide non-limiting examples of the present subject matter—it is not intended to provide an exclusive or exhaustive explanation. The Detailed Description below is included to provide further information about the present devices, systems, and methods.

### BRIEF DESCRIPTION OF DRAWINGS

This written disclosure describes illustrative embodiments that are non-limiting and non-exhaustive. Reference is made to illustrative embodiments that are depicted in the figures, in which:

FIG. 1A illustrates an isometric side view of a pulverizer apparatus with one or more side walls removed for viewing purposes, according to some embodiments.

FIG. 1B illustrates a top isometric view of a pulverizer apparatus with one or more side walls removed for viewing purposes, according to some embodiments.

FIG. 1C illustrates a bottom isometric view of a pulverizer apparatus with one or more side walls removed for viewing purposes, according to some embodiments.

FIG. 2 illustrates an isometric side view of a pulverizer apparatus including a push bar, according to some embodiments.

FIG. 3 illustrates a diagrammatic view of a pulverizer system, according to some embodiments.

FIG. 4 illustrates a flow chart of a method of pulverizing solid waste material, according to some embodiments.

FIG. 5 illustrates an isometric view of rail assembly, according to some embodiments.

### DETAILED DESCRIPTION

According to some embodiments, this disclosure relates to a linear pulverizer apparatus. The linear pulverizer apparatus may utilize linear motion (i.e., non-rotational motion) to pulverize solid waste materials such as wood pallets, wood boards, drywall, siding, ducting, etc. A first rail assembly including a plurality of teeth may be driven along a first linear path by a linear actuator to intersect a second rail assembly. The use of the linear actuator (e.g., piston, hydraulic cylinder, hydraulic press, etc.) as opposed to a rotational actuator (e.g., a rotationally powered fragmentation device such as a rotor or hammer mill) simplifies the power delivery of the apparatus. For example, a gearbox may not be required to deliver power to the linear actuator, whereas a gearbox is often required to deliver power to a rotational actuator. A gearbox for a large-scale, solid waste pulverizer may be extremely costly to manufacture and install, and therefore, the linear pulverizer apparatus may be a cost-effective alternative to rotationally powered fragmentation devices.

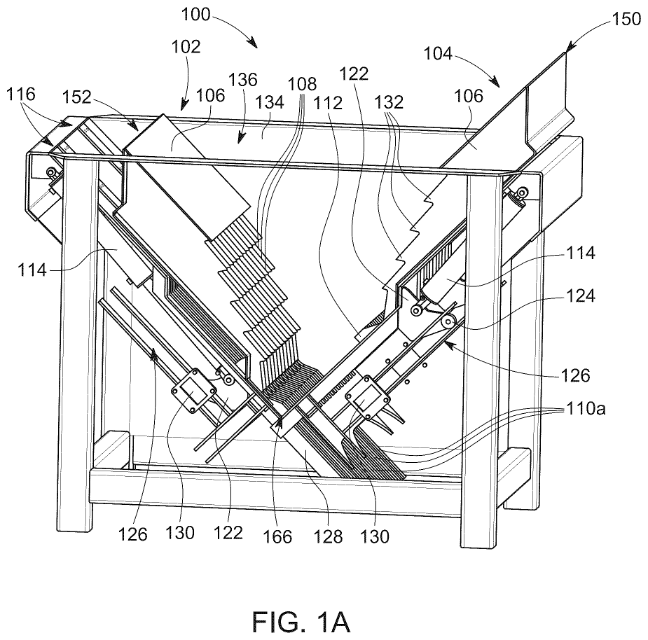

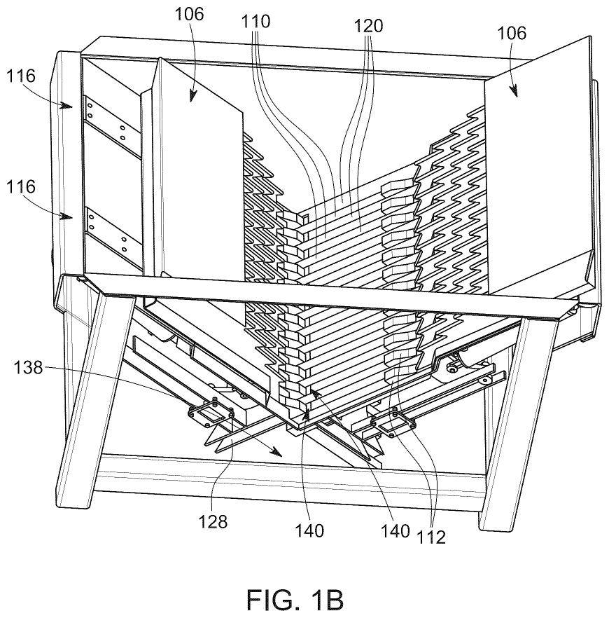

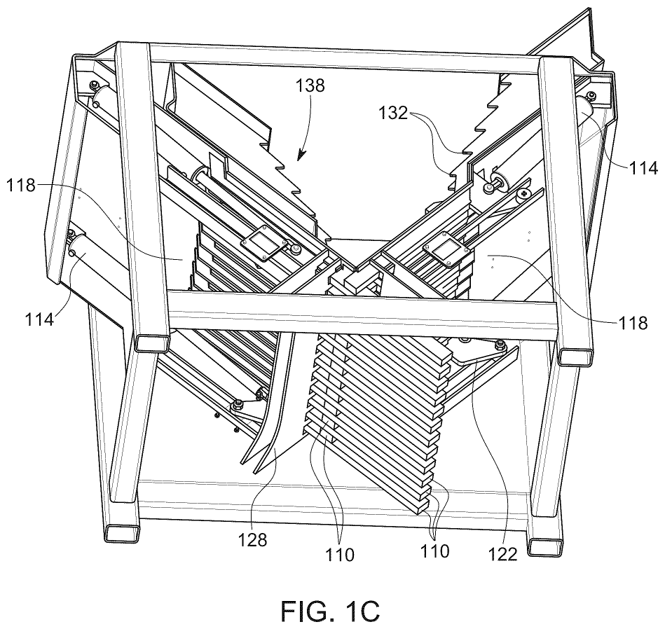

FIGS. 1A-C illustrates an isometric views of a linear pulverizer apparatus 100 with one or more side walls removed for viewing purposes, according to some embodiments. For instance, FIG. 1A illustrates an isometric side view of the linear pulverizer apparatus 100 with the front-facing side wall removed. The linear pulverizer 100 may include a first rail assembly 102 and a second rail assembly 104. The first rail assembly 102 and the second rail assembly 104 may each include a ram portion 106 having a plurality of ram teeth 108 and a plurality of rails 110a, 110b (referred to collectively as the rails 110). The plurality of rails 110 may be spaced apart from one another by a gap. As referred to hereinafter, the first rail assembly 102 may include a first plurality of rails 110a spaced apart from one another by first gaps and the second rail assembly 104 may include a second plurality of rails 110b spaced apart from one another by second gaps.

The first rail assembly 102 may intersect the second rail assembly 104, namely, the first plurality of rails 110a may be received within the second gaps of the second rail assembly 104. The second plurality of rails 110b may be received within the first gaps of the first rail assembly 102. In some embodiments, the first gaps and the second gaps may have approximately equal widths. Each of the first plurality of rails 110a and each of the second plurality of rails 110b may have approximately equal widths. In other embodiments, the widths of the first gaps, the second gaps, each of the first plurality of rails 110a, and each of the second plurality of rails 110b may differ in relation to one other. The plurality rails 110 may include one or more rail teeth 112. The one or more rail teeth 112 may be configured to pulverize, grind, and/or impact solid waste material (not shown).

In some embodiments, the first plurality of rails 110a may define a first plane and the second plurality of rails 110b may define a second plane. The first plane may intersect the second plane at an angle of approximately 90°, that is, the first plurality of rails 110a and the second plurality of rails 110b may intersect at an angle of approximately 90°. In some embodiments, the first plane may intersect the second plane at an angle of between approximately 45° to 135°. The angle of intersection may control how quickly solid waste material reaches an intersection point 166 between the first plurality of rails 110a may define a first plane and the second plurality of rails 110b. For example, a steep angle (e.g., 45°) will funnel the solid material toward the intersection point more quickly than a flat angle (e.g., 135°). Controlling the rate at which solid material reaches the intersection point 166 may be important, as for example, solid material accumulation at the intersection point 166 may jam the linear pulverizer 100 and/or require additional force from a linear actuator 114. On the other hand, solid material accumulation at the intersection point 166 may increase the rate of pulverization (e.g., the time it takes to process solid waste material into processed waste material). Thus, controlling the angle of intersection may be important to optimize the rate of pulverization without overburdening the linear actuator 114.

The linear pulverizer 100 may include one or more linear actuators 114. For instance, the first rail assembly 102 may be operably connected to a linear actuator 114 and the second rail assembly 104 may be operably connected to another linear actuator 114. The linear actuator 114 may include a piston, a hydraulic cylinder, a hydraulic press, or any other linear actuation device known in the art. Actuation of the one or more linear actuators 114 may urge the rail assembly 102, 104 to move along a linear path between a first position 150 (i.e., an uppermost position where the linear actuator 114 is retracted) and a second position 152 (i.e., a lowermost position where the linear actuator 114 is deployed). For example, FIG. 1A shows the first rail assembly 102 in the second position 152 with the corresponding linear actuator 114 deployed, and the second rail assembly 104 in the first position 150 with the corresponding linear actuator 114 retracted. The linear actuator 114 may continuously deploy and retract, urging the corresponding rail assemblies 102, 104 between the first position 150 and second position 152.

In some embodiments, movement along the first linear path and/or the second linear path may be guided by slide channels 116. The slide channel 116 may limit travel of the rail assembly 102, 104 to two directions—forward and backward along the linear path. The slide channel 116 may be oriented parallel to the first/second linear path. Movement along the first/second linear path may be guided by an alignment feature 124 traveling within guide rail 126. The linear actuator 114 may be secured to a piston plate 122 with the alignment feature 124 mounted thereon. The alignment feature 124 may be contained within the guide rail 126 oriented parallel to the first/second linear path. Thus, actuation of the rail assembly 102, 104 may be guided by one or more rails and/or alignment mechanisms oriented parallel to the respective linear path.

In some embodiments, the linear actuator 114 may not be limited to two-degrees of freedom (forward and backward). For instance, the linear actuator 114 may include a cam and/or a pivot joint (now shown) configured to induce motion of the rail assembly 102, 104. Thus, the first and/or second linear path may not be a straight-line, but could include an arced and/or curved path.

In some embodiments, the one or more linear actuators 114 may be positioned adjacent to a side wall 134. For instance, in the embodiment illustrated in FIGS. 1A-C, both the first rail assembly 102 and the second rail assembly 104 are each secured to two linear actuators 114, wherein each of the linear actuators 114 are positioned adjacent to the side wall 134 (one side wall 134 removed for viewing purposes). Such configuration may be beneficial, as the guide rail 126 may be mounted on the side wall 134 via a side wall support bracket 130. The two linear actuators 114 may be positioned to evenly distribute the load across the width of the rail assembly 102, 104.

The one or more linear actuators 114 may include a selectable actuation rate. The actuation rate may be defined as the speed of actuation between the first position 150 and the second position 152 (and/or vice-versa). An actuation cycle may be completed once the rail assembly 102, 104 travels from the first position 150 to the second position 152, and returns back to the first position 150. In some embodiments, the actuation rate may be approximately 15 actuation cycles per minute. In some embodiments, the actuation rate may be between 5 and 30 actuation cycles per minute. Selection of the actuation rate may control the rate and/or efficiency of the solid waste processing. For example, a faster actuation rate may process solid waste faster than a slow actuation rate, while a faster actuation rate may require more energy/power to operate than a slow actuation rate.

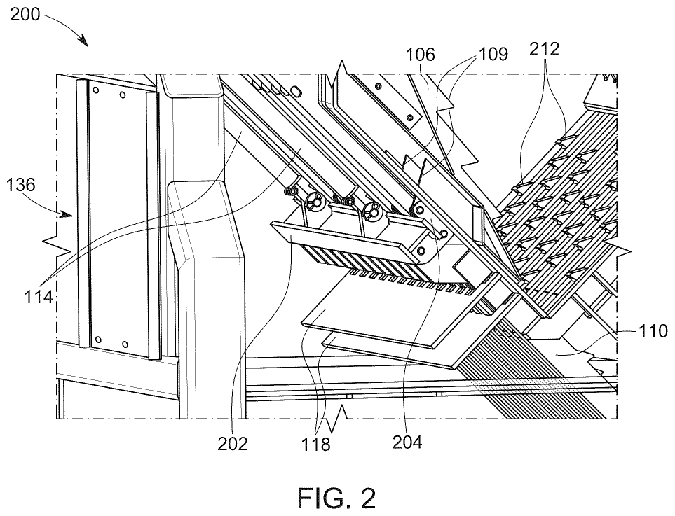

In some embodiments, the actuation rate may vary depending on the resistance experienced by the rail assembly 102, 104. For example, if solid waste accumulates at the intersection point 166, additional force/power may be required to actuate the rail assembly 102, 104. Thus, the actuation of the rail assembly 102, 104 may temporarily slow as additional power is provided to the linear actuator. The one or more linear actuators 114 may be operably connected to a prime mover (see e.g., the prime mover 144 in FIG. 2). In some embodiments, power from the prime mover may be distributed to the one or more linear actuators 114 based-on the resistance encountered by the rail assembly 102, 104.

The one or more linear actuators 114 may include a selectable phase. For example, the linear pulverizer 100 in FIGS. 1A-C is shown in an off-phase state where the first rail assembly 102 is in the second position and the second rail assembly 104 is in the first position 150. Stated differently, the linear actuator 114 connected to the first rail assembly 102 is fully extending while the linear actuator 114 connected to the second rail assembly 104 is fully retracted. Thus, the linear pulverizer 100 shown in FIGS. 1A-C is in an off-phase state. In other embodiments, the linear pulverizer 100 may operate in an on-phase state where the first rail assembly 102 and the second rail assembly 104 oscillate simultaneously. In other embodiments, the linear pulverizer 100 may operate in a partially on-phase and/or a partially off-phase state.

In some embodiments, solid waste material (not shown) may be inserted through a first opening 136 (i.e., a top opening). The processed waste material (not shown) may exit the linear pulverizer 100 via a second opening 138 (i.e., a bottom opening). In some embodiments, the path from the first opening 136 to the second opening 138 may be gravity-assisted, i.e., the waste material may be at least partially moved through the linear pulverizer 100 by gravity. The ram teeth 108 and/or the rail teeth 112 may move the waste material from the first opening 136 to the second opening 138. For instance, the ram teeth 108 may be pointed toward the second opening 138 to engage waste material as the linear actuator 114 moves toward the second opening.

In some embodiments, the ram portion 106 may be primarily configured to direct solid waste material to the intersection point 166, i.e., actuation of the ram portion 106 may break-apart/process a portion of the solid waste, but the primary purpose of the ram portion 106 is to urge solid waste material toward the intersection point 166. The ram portion 106 may urge the solid waste material against the corresponding rail assembly 102, 104. For instance, the ram portion 106 on the first rail assembly 102 may actuate and urge solid waste material against the second plurality of rails 110b on the second rail assembly 104. Solid waste material may be pinched between the ram teeth 108 and the corresponding rail assembly 102, 104, and as the corresponding rail assembly 102, 104 actuates, the rail teeth 112 may engage the solid waste material and punch the solid waste material through the gaps in the corresponding rail assembly 102, 104.

In some embodiments, the linear pulverizer 100 may include a stationary plate 118 having a plurality of stationary members 120. For instance, FIG. 1B illustrates the plurality of stationary members 118 received within the second gaps of the second plurality of rails 110b. The stationary plate 118 may be secured to the linear pulverizer 100 via one or more stationary plate brackets 128. The stationary plate bracket 128 may be secured to the side wall 134. In some embodiments, the stationary plate 118 may prevent large or unprocessed solid waste from falling through the second opening 138 of the linear pulverizer 100 prematurely. For instance, if the stationary members 120 were removed from FIG. 1B, solid waste may fall through the first gaps between the first plurality of rails 110a and/or the second gaps between the second plurality of rails 110b and exit the linear pulverizer 100 via the second opening 138. In some embodiments, a plurality of gaps 140 (sec e.g., FIG. 1B) may be formed between the stationary plate 118 and the plurality of rails 110 (e.g., in FIG. 1B, the gaps 140 are formed between the first plurality of rails 110a and the stationary members 120). The gaps 140 may allow small, or processed, waste materials to pass through. Thus, the size of the gaps 140 may control the degree of processing of the solid waste material. For instance, if the gaps 140 have a large size, larger waste can fit through, whereas if the gaps have a small size, only small, finely processed wasted can fit through.

In some embodiments, the gaps 140 may be sized to receive the rail teeth 112 therethrough. The rail teeth 112 may engage the waste material (not shown) and punch/push the waste material through the gap 140. The waste material may then fall through the second opening 138 and out of the linear pulverizer 100 as processed waste material.

FIG. 2 illustrates an isometric side view of a linear pulverizer apparatus 200, according to some embodiments. The linear pulverizer apparatus may include a push bar 202 secured to the one or more linear actuators 114. The push bar 202 may include a bracket 204 secured to the ram portion 106 of the rail assembly 102, 104. In some embodiments, the push bar 202 may include a plurality of brackets 204, wherein each bracket 104 is secured to a plate 109 of the ram portion 106. The linear pulverizer apparatus 200 may include the plurality of rails 110 having a plurality of rail teeth 212. The plurality of rail teeth 212 may include an angled and/or concave surface configured to engage waste material. Other shapes and/or configurations of rail teeth 112, 212 are contemplated. The push bar 202 may distribute a load across the rail assembly 102, 104.

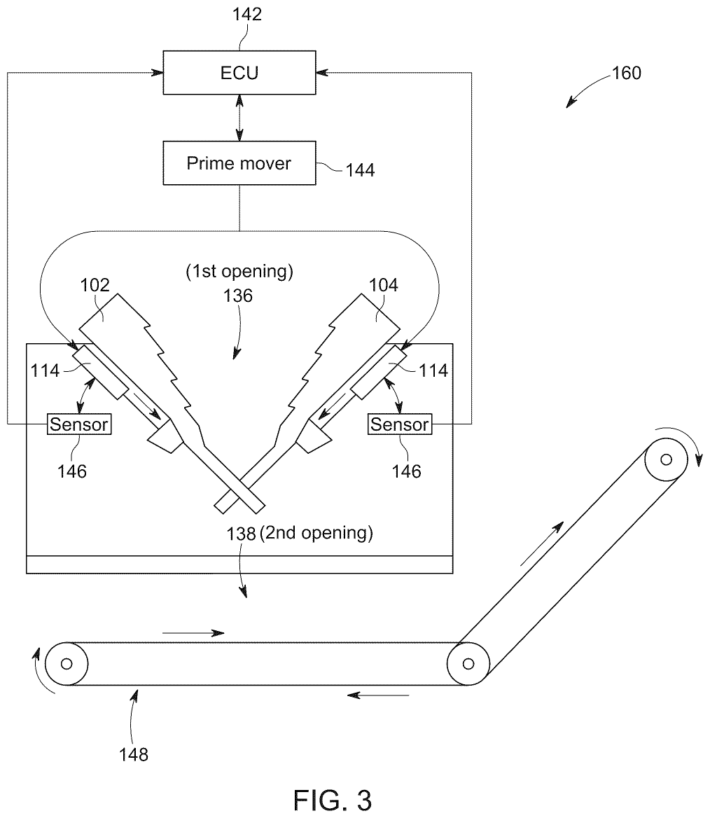

FIG. 3 illustrates a diagrammatic view of a pulverizer system 160, according to some embodiments. The pulverizer system 160 may include the linear pulverizer apparatus 100 discussed above with respect to FIGS. 1A-C or the linear pulverizer apparatus 200 discussed above with respect to FIG. 2. A prime mover 144 provides power to the linear actuator 114. In some embodiments, the prime mover 144 includes one or more of an internal combustion engine, an internal combustion generator, an electric motor, a hydraulic power unit, and/or any other prime mover known in the art. The prime mover 144 may be in electrical communication with an electronic control unit (ECU) 142.

In some embodiments, the pulverizer system 160 may include one or more sensors 146 in communication with the linear actuator 114 and/or the prime mover 144. The sensor 146 may include a force sensor configured to measure resistance experienced by the linear actuator 114. For example, if dense, solid material accumulates at the intersection point 166, a high force may be required to fully actuate the rail assembly 102, 104. The sensor 146 may measure and communicate the mechanical resistance encountered by the linear actuator 114. In some embodiments, the ECU 142 may adjust and/or redistribute power delivered to the linear actuator 114 based on the communication from the sensor 146. For example, the prime mover 144 may deliver power to the linear actuator 114 connected to the first rail assembly 102 and to the linear actuator 114 connected to the second rail assembly 104. The ECU 142 may selectively control the power distribution to the linear actuators 114, and if high resistance is measured by the sensor 146, the ECU 142 may increase the power distribution to the corresponding linear actuator 114.

In some embodiments, the ECU 142 may control the actuation rate and/or actuation phase of the rail assemblies 102, 104. The actuation rate and/or actuation phase of the rail assemblies 102, 104 may be adjusted based on data received from the sensor 146. For instance, if the sensor 146 measures high levels of mechanical resistance during actuation, the ECU 142 may decrease the actuation rate to increase the power delivered on each actuation cycle (and/or vice-versa). In some embodiments, if a high mechanical resistance is measured by the sensor 146 during actuation, the ECU 142 may pause actuation of the other rail assembly 102, 104 and divert all power from the prime mover 144 to the corresponding linear actuator 114.

The pulverizer system 160 may include a conveyer belt assembly 148. The conveyer belt assembly 148 may be positioned under the second opening 138 of the linear pulverizer 100. Processed waste material may exit the second opening 138 and fall onto the conveyer belt assembly 148 via gravity. The one or more side walls 136 may be positioned to contain all processed waste material until the processed waste exits the linear pulverizer at the second opening 138. The conveyer belt assembly 148 may transport the processed waste material from the linear pulverizer 100 to a second location to prevent buildup of processed waste directly under the linear pulverizer 100. In some embodiments, the conveyer belt assembly 148 may be in operable communication with the ECU 142 and/or the primer mover 144.

In some embodiments, the pulverizer system 160 may include an auto-stop function. The auto-stop function may be configured to pause/stop actuation of the rail assemblies 102, 104 when all of the solid waste material inserted into the linear pulverizer 100 through the first opening 136 has exited the linear pulverizer 100 through the second opening 138. The ECU 142 may receive signals from the sensor 146 indicating the mechanical resistance encountered on an actuation of the linear actuator 114. If the measured mechanical resistance falls below a threshold level for a number of successive actuation cycles, the ECU 142 may determiner that all solid waste material has been processed and actuation of the rail assemblies 102, 104 may stop/pause. In some embodiments, a clearing actuation cycle may be initiated prior to the auto-stop. The clearing actuation cycle may be configured to change the actuation rate and/or actuation phase to free any excess solid waste remaining in the linear pulverizer 100.

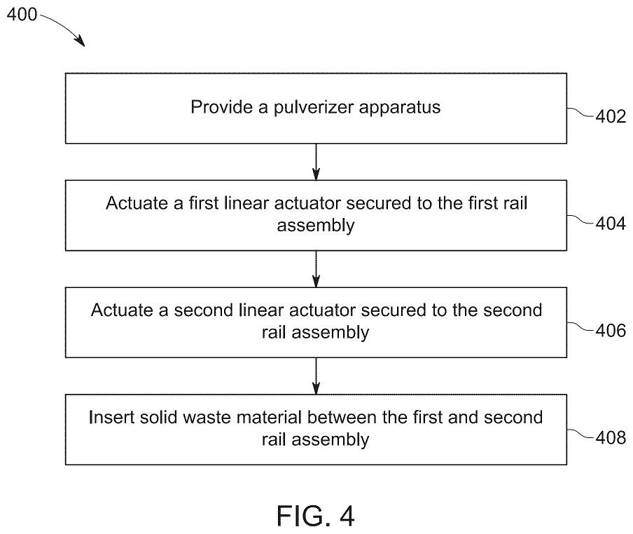

FIG. 4 illustrates a method of pulverizing solid waste material. The method 400 includes step 402, providing a pulverizer apparatus. The pulverizer apparatus may include any or all elements of the linear pulverizer apparatus 100 described in FIGS. 1A-1C and/or any or all elements of the linear pulverizer apparatus 200 described in FIG. 2. For instance, the pulverizer apparatus 100 may include the first rail assembly 102 including the first plurality of rails 110a separated from each other by first gaps and the second rail assembly 104 including the second plurality of rails 110b separated from each other by second gaps.

The method 400 may include step 404, actuating a first linear actuator secured to the first rail assembly 102. The first linear actuator may include any and/or all of the features described in connection with the linear actuator 114. The first rail assembly 102 may be movable along a first linear path, e.g., the first rail assembly 102 may be movable between the first position 150 and the second position 152 via actuation of the first linear actuator 114.

The method may include step 406, actuating a second linear actuator secured to the second rail assembly 104. The second linear actuator may include any and/or all of the features described in connection with the linear actuator 114. The second rail assembly 104 may be movable along a second linear path, e.g., the second rail assembly 104 may be movable between the first position 150 and the second position 152 via actuation of the second linear actuator 114.

The method 400 may include step 408, inserting solid waste material between the first rail assembly 102 and the second rail assembly 104. In some embodiments, the solid waste material may be inserted through the first opening 136 and travel toward the first rail assembly 102 and the second rail assembly 104 via gravity. The first linear path may intersect the second linear path, and thus, actuation of the first linear actuator in step 304 and actuation of the second linear actuator in step 306 may pulverize the solid waste material.

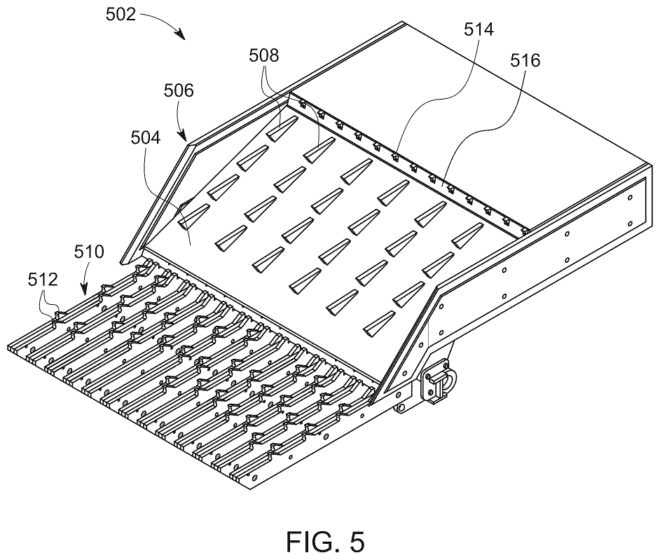

FIG. 5 is an isometric view of a rail assembly 502, according to some embodiments. The rail assembly 502 includes a ram portion 506 including a plurality of first ram teeth 508 disposed on a ram surface 504 and a plurality of second ram teeth 514 positioned on an upper end 516 of the ram surface 504. The rail assembly 502 includes a plurality of rails 510 including offset rail teeth 512, according to some embodiments.

In some embodiments, the plurality of first ram teeth 508 are distributed in columns along the ram surface 504. For instance, the embodiment shown in FIG. 5 includes four of the first ram teeth 508 per column, with six columns on the ram surface 504. The plurality of second ram teeth 514 are positioned on the upper end 516, and in some embodiments, are distributed in a row across the upper end 516 of the ram surface 504. The plurality of rails 510 include the offset rail teeth 512. The offset rail teeth 512 are offset across a width of each of the plurality of rails 510, i.e., instead of a single tooth extending across a rail, multiple offset teeth extend across the rail. In some embodiments, the offset rail teeth 512 of each of the plurality of rails 510 are coupled to a central rail. The offset rail teeth 512 can therefore be replaced after extended use without replacing the entire rail assembly 502 and/or the plurality of rails 510. The rail assembly 502 can be used in combination with any of the above features/elements described above in any of FIGS. 1A-4.

The above Detailed Description includes references to the accompanying drawings, which form a part of the Detailed Description. The Detailed Description should be read with reference to the drawings. The drawings show, by way of illustration, specific embodiments in which the present devices, systems, and methods can be practiced. These embodiments are also referred to herein as “examples.”

The Detailed Description is intended to be illustrative and not restrictive. For example, the above-described examples (or one or more features or components thereof) can be used in combination with each other. Other embodiments can be used, such as by one of ordinary skill in the art upon reviewing the Detailed Description and accompanying drawings. Also, various features or components have been or can be grouped together to streamline the disclosure. This should not be interpreted as intending that an unclaimed disclosed feature is essential to any claim. Rather, inventive subject matter can lie in less than all features of a disclosed embodiment.

Certain terms are used throughout this patent document to refer to features or components. Different people may refer to the same feature or component by different names. This patent document does not intend to distinguish between components or features that differ in name but not in function.

The scope of the present devices, systems, and methods should be determined with reference to the appended claims, along with the full scope of equivalents to which such claims are entitled. In the appended claims, the terms “including” and “in which” are used as the plain-English equivalents of the respective terms “comprising” and “wherein.” Also, in the following claims, the terms “including” and “comprising” are open-ended; that is, a device, system, or method that includes features or components in addition to those listed after such a term in a claim are still deemed to fall within the scope of that claim. Moreover, in the following claims, the terms “first,” “second” and “third,” etc. are used merely as labels, and are not intended to impose numerical requirements on their objects.

The Abstract is provided to allow the reader to quickly ascertain the nature of the technical disclosure. It is submitted with the understanding that it will not be used to interpret or limit the scope or meaning of the claims.

What is claimed is:

1. A pulverizer apparatus, comprising:
a first rail assembly including a first plurality of rails, each of the first plurality of rails separated from each other by first gaps;
a second rail assembly including a second plurality of rails separated from each other by second gaps; and
a first linear actuator secured to the first rail assembly, the first rail assembly movable along a first linear path via actuation of the first linear actuator,
wherein the first plurality of rails is receivable in the second gaps of the second rail assembly.

2. The pulverizer apparatus of claim 1, wherein the first plurality of rails extends along a first plane and wherein the second plurality of rails extends along a second plane, the first plane intersecting the second plane, wherein actuation of the first linear actuator urges the first plurality of rails through the second gaps of the second rail assembly.

3. The pulverizer apparatus of claim 2, wherein the first plurality of rails includes at least one rail tooth, wherein actuation of the first linear actuator urges the at least one rail tooth of the first plurality of rails through the second plane.

4. The pulverizer apparatus of claim 3, further comprising a stationary plate located parallel to the second plane including a plurality of members disposed between each of the second plurality of rails.

5. The pulverizer apparatus of claim 4, further comprising:
a second linear actuator secured to the second rail assembly, the second rail assembly movable along a second linear path via actuation of the second linear actuator,
wherein the plurality of second rails includes at least one rail tooth, and
wherein actuation of the second linear actuator urges the second plurality of rails through the first gaps of the first rail assembly.

6. The pulverizer apparatus of claim 5, wherein actuation of the second linear actuator urges the at least one rail tooth of the second plurality of rails of through the first plane.

7. The pulverizer apparatus of claim 2, wherein the first plane intersects the second plane at an angle within a range of 45° and 135°.

8. The pulverizer apparatus of claim 1, wherein the first rail assembly includes a ram portion having a plurality of ram teeth.

9. The pulverizer apparatus of claim 1, wherein the first rail assembly includes an piston plate, wherein the first linear actuator is secured to the piston plate, wherein the first linear actuator includes a hydraulic piston oriented parallel to the first linear path.

10. The pulverizer apparatus of claim 1, further comprising one or more slide channels oriented parallel to the first linear path, wherein actuation of the first rail assembly is guided by the one or more slide channels.

11. A pulverizer system, comprising:
a first rail assembly including a first plurality of rails extending along a first plane, each of the first plurality of rails separated from each other by first gaps and the first plurality of rails including at least one rail tooth;
a second rail assembly including a second plurality of rails extending along a second plane, each of the second plurality of rails separated from each other by second gaps, the first plurality of rails receivable in the second gaps and the second plurality of rails receivable in the first gaps;
a first linear actuator secured to the first rail assembly, the first linear actuator actuatable along a first linear path to urge the first rail assembly at least partially through the second gaps of the second rail assembly;
a second linear actuator secured to the second rail assembly, the second linear actuator actuatable along a second linear path to urge the second rail assembly at least partially through the first gaps of the first rail assembly; and
a prime mover, wherein the prime mover provides power to one or more of the first linear actuator and the second linear actuator.

12. The pulverizer system of claim 11, further comprising:
one or more side walls including a top end and a bottom end, the one or more side walls defining a first opening located at the top end of the one or more side walls and a second opening located at the bottom end of the one or more side walls,
wherein solid waste material is insertable into the first opening, and
wherein processed waste material exits the pulverizer system through the second opening.

13. The pulverizer system of claim 11, wherein the first rail assembly and the second rail assembly each include a plurality of teeth, wherein the plurality of teeth is configured to pulverize solid waste material into processed waste material.

14. The pulverizer system of claim 11, further comprising an electronic control unit (ECU) in communication with one or more of the first linear actuator, the second linear actuator, and the prime mover, the ECU configured to control a timing of the first linear actuator and the second linear actuator.

15. The pulverizer system of claim 14, wherein the ECU selectively distributes the power from the prime mover to the first linear actuator and the second linear actuator.

16. The pulverizer system of claim 15, further comprising a force sensor in one or more of the first linear actuator and the second linear actuator, wherein the ECU may selectively control an ON/OFF state based on data received from the force sensor.

17. The pulverizer system of claim 12, further comprising a conveyer belt assembly located at the second opening, wherein the processed waste material is receivable on the conveyer belt assembly.

18. A method of pulverizing waste material, the method comprising:
providing a pulverizer apparatus including:
a first rail assembly including a first plurality of rails separated from each other by first gaps, and
a second rail assembly including a second plurality of rails separated from each other by second gaps;
actuating a first linear actuator secured to the first rail assembly, the first rail assembly movable along a first linear path via actuation of the first linear actuator;
actuating a second linear actuator secured to the second rail assembly, the second rail assembly movable along a second linear path via actuation of the second linear actuator; and
inserting solid waste material between the first rail assembly and the second rail assembly,
wherein the first linear path intersects the second linear path.

19. The method of claim 18, wherein the first linear path intersects the second linear path at an angle of between 45° and 135°.

20. The method of claim 18, wherein the first rail assembly and the second rail assembly each include a plurality of teeth, wherein the plurality of teeth pulverizes the solid waste material during actuation of the first rail assembly and the second rail assembly, and wherein a processed waste material falls through gaps between the first rail assembly and the second rail assembly.
